(19) United States
(12) Patent Application Publication
(10) Pub. No.: US 2004/0186784 A1
(43) Pub. Date: Sep. 23, 2004

(54) Method and computer programme for processing information on product request processes

(76) Inventors: Daniel-Rui Felicio, Munchen (DE); Markus Moll, Munchen (DE); Angela Quint, Iffeldorf (DE); Andreas-Christoph Raabe, Untermeitingen (DE); Peter Stauch, Holzkirchen (DE)

Correspondence Address: MORRISON & FOERSTER LLP, 1650 TYSONS BOULEVARD, SUITE 300, MCLEAN, VA, 22102, US

(21) Appl. No.: 10/476,302

(22) PCT Filed: Apr. 30, 2002
(86) PCT No.: PCT/DE02/01572

(30) Foreign Application Priority Data
Apr. 30, 2001 (DE) 10121263.1

(51) Int. Cl. G06F 17/60

(52) U.S. Cl. 705/22

(57) ABSTRACT

The invention relates to a method and computer programme for processing information on product request processes, in which product information is visualised on a user interface device by means of at least one product identifier and a function for producing a product availability request for at least a first user is prepared for activation. On activation of said function a user and product identifier are polled, a request process file for product request process information, which may be addressed by means of a request process identifier, is generated, the user and the product identifier are entered in the request process file and a message containing the request process identifier is sent to at least a second user. After generation of the request process file the above is made available to the second user for editing. After the entries in the request process file have been confirmed by the second user, a function for generation of a product order for the first user is prepared for activation.

WO 99/33016 discloses a method for processing order processes in which an order database and a database management system are used. The starting point of the method described in this disclosure is the electronic receipt of a user request. Once the user request has been received, at least one order data record is created in the order database, where it remains stored for the duration of the order process. A large number of users access the order data record during the order process in order in each case to complete at least one of a multiplicity of business functions and thereby create additional data records that are related to the order data record.

One disadvantage of the method known from WO 99/33016 is that the electronically received user request has to have a specific format in order for the method to be able to evaluate the information it contains and transfer it to an order data record. If the information in an original user request cannot be evaluated, the user must be asked to correct the user request and resubmit the corrected version. This leads not only to increased data traffic when processing order processes, but also to a time delay, especially since the original user request has to be compared with at least one corrected version in order for the corrected version to be identified as the relevant corrected version.

The object of the present invention is to create a faster and more reliable method for processing product request information.

This object is achieved in accordance with the invention by a method having the features specified in claim 1 and by a computer program having the features specified in claim 8. Advantageous developments of the invention are specified in the dependent claims.

The invention provides for a user identifier and a product identifier to be polled when a function for producing a product availability request is activated by a first user and for the user identifier and product identifier to be entered in a request process file that may be addressed by means of a request process identifier. This request process file is provided for product request process information and is generated on activation of the function for producing a product availability request. Activation of the function for producing a product availability request also triggers the sending of a message containing the request process identifier to a second user. Once generated, the request process file is made available to the second user for editing.

The second user may, for example, check the content of the request process file using the user identifier and the product identifier and confirm it where appropriate. It is not necessary in this process for the request process file to have any special format and is sufficient merely for the user identifier and product identifier to be legible for the second user. Once the entries in the request process file have been confirmed by the second user, a function for generating a product order is made available to the first user for activation.

The request process file that the first and second users access during the product request process and in which they enter, check and confirm information is one and the same request process file, so there is no need, for example, for any transfer of information contained in a user request to order data records in an order database with all of the associated drawbacks. Incorrect entries by the first or second user can be prevented from the outset by providing special entry fields in the request process file and by means of predefinable validity rules for these entry fields. This further increases speed and makes the method for processing information on product request processes more reliable.

The invention is described in more detail below with reference to the drawings.

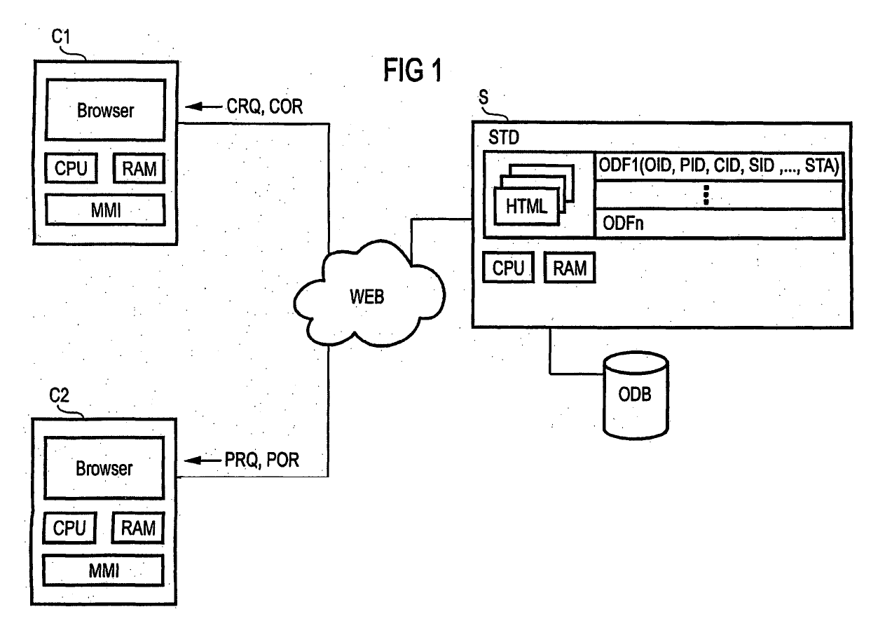

FIG. 1 shows an arrangement with two client systems and a server system that are connected to each another by a data network.

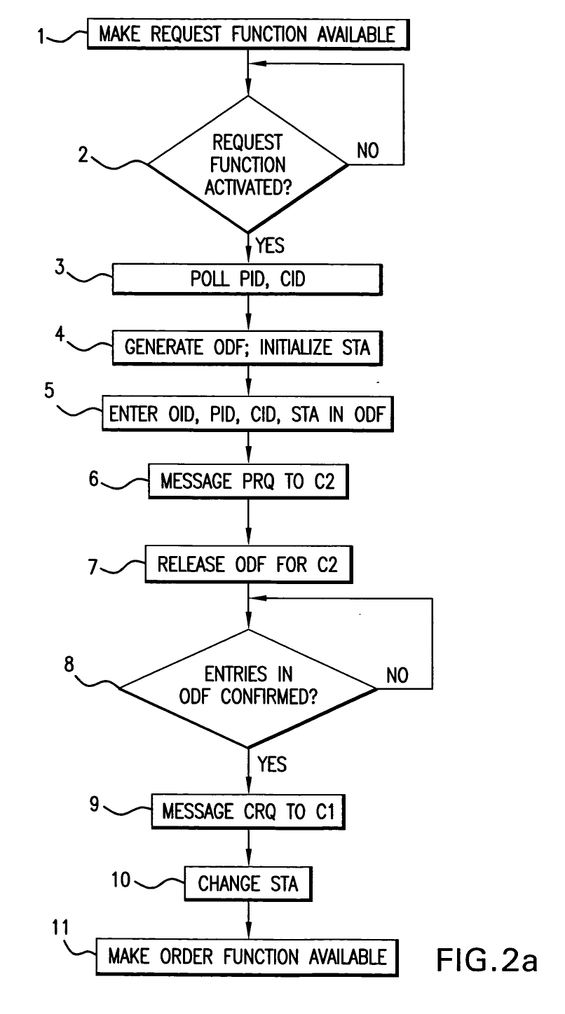

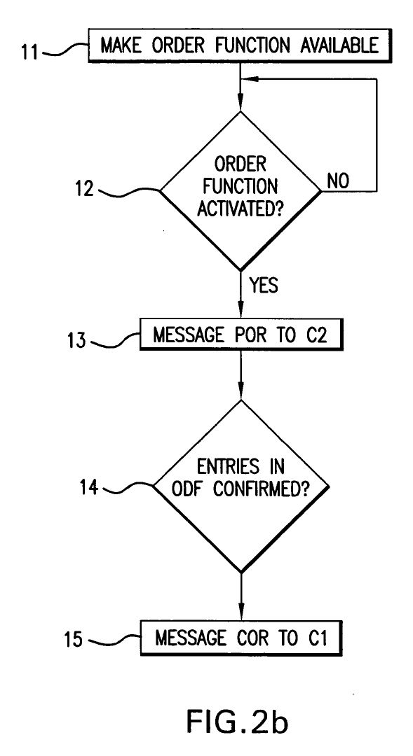

FIGS. 2a and 2b show a flowchart for a method for processing information on product request processes.

FIG. 1 shows two client systems C1, C2 and a server system S that are connected to each other by a data network WEB. The data network WEB in the present exemplary embodiment is the internet. Numerous other data networks, such as local area networks (LAN), wide area networks (WAN) and point-to-point dial-up connections, may be used instead of the internet.

Numerous data processing systems and networks not shown in any more detail in FIG. 1 are connected in the internet WEB by a multiplicity of data communication links. The interconnected data processing systems are thus able to exchange information using numerous services such as e-mail, gopher or the world wide web. The world wide web service enables the client systems C1, C2 to retrieve information with text and graphics content stored in server system S.

Every resource, such as a computer or retrievable information, in the internet WEB can be addressed by means of a unique identifier, the Uniform Resource Locator (URL). Specific information with text and/or graphics content is retrieved from the server system S by specifying the Uniform Resource Locator assigned to this information in a request to be sent by a client system C1, C2 to the server system S. The request is sent to the server system S in accordance with the Hypertext Transfer Protocol (HTTP). When the server system S receives the request, it sends the requested information to the requesting client system C1, C2.

Information with text and/or graphics content that is stored in the server system S such that it can be retrieved is formatted in accordance with the Hypertext Markup Language (HTML). The Hypertext Markup Language provides a basic set of displayable characters and fonts that can be used to produce retrievable information with text and/or graphics content. This means that information requested by a client system C1, C2 is sent from the server system S to the relevant client system C1, C2 as HTML documents formatted in accordance with the Hypertext Markup Language. When a client system C1, C2 receives a requested HTML document, this document is visualized at a user interface device MMI of the relevant client system C1, C2 using a special application program. Application programs for this purpose are generally known as browsers.

An HTML document contains numerous control codes that define how the text, graphics and program control elements or independent documents are to be visualized. An HTML document can of course also contain Uniform Resource Locators for other information stored in retrievable form in the server system S or in other server systems not shown in more detail in FIG. 1.

The internet WEB is particularly well suited for conducting trade by electronic means. Numerous server systems are provided for suppliers for the purposes of advertising their products and/or services and seeking to sell the same. The products and services may in this connection contain components that are sent to the buyer electronically over the internet WEB or components that are delivered through conventional sales channels. Stored in the server system S is a catalog, not shown in any more detail, containing orderable products and/or services in the form of HTML documents. A potential buyer can search the catalog for products and/or services the availability of which the potential buyer wishes to query using a browser installed on a client system C1, C2. Having received confirmation that the products and/or services of interest are available and been presented with the associated terms and conditions, the potential buyer may place an order. The order may in addition be confirmed by the supplier concerned.

The server system S shown in FIG. 1 has a microprocessor CPU, a working memory RAM and a storage device STD for HTML documents and for request process files ODF1-ODFn. The client systems C1, C2 each have a microprocessor CPU, a working memory RAM and a user interface device MMI plus a browser to display HTML documents at the relevant user interface device MMI.

The starting point for the flowchart shown in FIG. 2a is a visualization of product information with at least one product identifier PID at the user interface device MMI of a client system C1 of a first user (customer) and the making available to the first user of a function for producing a product availability request (Step 1). The product information is stored in the server system S as HTML documents in a retrievable form and is sent on demand to the client system C1 of the first user. Monitoring to detect an activation of the function for producing a product availability request begins as soon as the function is made available (Step 2).

If this function is activated, the first user at the user interface device MMI of the client system C1 is polled for a user identifier CID and a product identifier PID (Step 3). A request process file ODF1 for product request process information, which request process file ODF1 may be addressed by means of a request process identifier OID, is also generated (Step 4). The request process identifier OID is generated here in the server system S. A file status memory STA assigned to the request process file ODF1 is also initialized when the latter is generated. Entries stored in the request process file ODF1 are made available for editing to the first user and/or to a second user (supplier) depending on a value stored in the file status memory STA. A reserved area in the request process file ODF1 is made available for the file status memory STA in the present example.

Once the request process file ODF1 has been generated and the file status memory STA has been initialized, the user identifier CID of the first user and the product identifier PID are entered in the request process file ODF1 (Step 5). A message PRQ containing the request process identifier OID is sent to the client system C2 of the second user to notify the second user that a new product availability request has been made (Step 6). The second user may be determined, for example, using the product identifier PID and a supplier database, not shown in any more detail in FIG. 1, that is assigned to the server system S. The supplier database here contains assignments between products and/or services and the corresponding supplier.

Not only supplier data, but also more detailed customer and product data can be sent in the same way from a customer or product database to the request process file by means of the user identifier and/or product identifier. This offers the advantage that the progress of a request, order and delivery process is clearly documented throughout, as the data applicable to each of the events is recorded in the request process file in a way that would not be the case in the event of a link to data records that were always current. This is particularly helpful if data relating to customer or supplier addresses, bank account details and the like, for example, has to be changed during a request, order and delivery process.

Once the message PRQ has been sent to the second user, the request process file ODF1 is made available to the second user for editing (Step 7). This puts the second user in a position to confirm or, as the case may be, to correct entries stored in the request process file ODF1. A check is then made to ascertain whether the entries stored in the request process file ODF1 are confirmed by the second user (Step 8). If the entries stored in the request process file ODF1 are confirmed, a product availability request confirmation message CRQ is sent to the first user (Step 9). The value stored in the file status memory STA is also changed (Step 10) and a function for generation of a product order for the first user is prepared for activation (Step 11). The change made to the value stored in the file status memory STA has the effect that the request process file ODF1 is no longer treated as a product request document and is instead treated as a product order document.

The flowchart shown in FIG. 2b indicates that once the function for generation of a product order has been activated (Step 11), a check is made to determine whether this function is activated (Step 12). If the function is activated, corresponding order information is entered in the request process file ODF1 and a new product order message POR is sent to the second user for the purpose of notification (Step 13). A function for confirming a product order is also made available to the second user for activation. This function causes order information entered in the request process file ODF1 by the first user to be marked as having been confirmed by the second user. Checks are made constantly to determine whether the second user has confirmed the order information (Step 14). If the confirmation function is activated, the order information entered in the request process file ODF1 is marked correspondingly and a product order confirmation message COR is sent to the client system C1 of the first user (Step 15).

Only one request process file is made available in each case in the present example for each product availability request process and, where applicable, each product availability request process involving a subsequent order process. The entries stored in a request process file ODF1 may be sent to an object-oriented database ODB assigned to the server system S in order to safeguard data management. The entries may be sent at defined time intervals, for example, or on confirmation of a product availability request or order. The use of an object-oriented database offers the additional advantages that it makes searching for and managing information easier than would be the case with a hierarchical or relational database and that it is not necessary to partition the database tablespaces. Considered altogether these advantages result in significantly lower installation and administration overhead as compared with the use of hierarchical or relational databases.

A request process file ODFI-ODFn can be used for numerous types of auction. The supplier in the case of a standard auction of the “English auction” type defines the duration of the auction and the price at or above which the supplier undertakes to sell the product or service concerned. A contract of sale with a potential buyer is created at the end of the auction by determining which potential buyer submitted the highest bid provided that this bid exceeds the minimum price specified by the supplier. The contract of sale is then concluded with this potential buyer.

A request process file ODF1-ODFn can also be used for “Reverse auctions”, over the course of which prices fall rather than rise. Each potential buyer in this type of auction attempts to submit the lowest bid in order to be accepted for the purchase of a product or service.

A first variant (“Request for bids”) provides for products and/or services to be offered for sale by the supplier concerned with no obligation to sell. Potential buyers then submit binding purchase bids, as part of which they are able to define price and bid duration according to their own preferences. The supplier is able to select one of the valid purchase bids at any time and this selection then creates a contract of sale. It is not necessary in this connection for the supplier to select the highest bid: indeed the supplier has a completely free choice and can take into account the duration of the bids and its assessment of each potential buyer, for example, as well as the value of the bid. It is also possible for a supplier in a non-binding offer of this type to specify a minimum price and/or a suggested price range. Purchase bids that fall short of the minimum price or outside the suggested price range are then ignored.

A second variant provides for a supplier to start by offering products and/or services for sale. The supplier initiates the auction with a defined start price and auction duration. The auction begins with the start price as the current price and this price is continuously reduced in the course of the auction. Potential buyers, in other words, are able in the course of the auction to underbid the current price and bids are only accepted if they are lower than the current price.

Such bids are binding on the buyer. The potential buyer with the lowest bid at the end of the period allowed for the auction is the winner. If the lowest bid is below a minimum price that may be specified by the supplier, however, the potential buyer with the lowest bid does not have to be offered the opportunity to buy.

A third variant (“Dutch auction”) provides for a supplier to offer a product or service and to name a starting price as the initial current price and for this current price then to be reduced automatically by a predefined value after a predefined period of time. This takes place over a defined auction duration and/or a defined number of auction steps. Potential buyers are able to observe the progress of the auction for as long as the auction lasts. The auction ends as soon as a potential buyer confirms the purchase at a specific price. If the duration specified for the auction elapses without any potential buyer being prepared to buy the product or service offered at any of the current prices offered, the auction ends unsuccessfully and is closed.

A fourth auction variant (“Request for quotation”) provides for a potential buyer to specify a product or service that it would like to purchase through an auction. The potential buyer starts the auction with a defined target price by which it will be bound and a defined auction duration. Suppliers are able to submit bids over the course of the auction. Each bid is binding on the supplier concerned. The potential buyer must satisfy the contract as soon as a bid meets the target price specified by the potential buyer. If the auction ends without any bid meeting the target price specified by the potential buyer, the least expensive bid is automatically determined and the corresponding supplier wins the auction. A manual selection process may be used in place of the automatic selection process.

The method for processing information on product request processed described in the preceding is implemented by a computer program that can be loaded into the working memory RAM of the server system S and has code sections on the execution of which the steps described above are executed if the computer program is running on the server system S.

The present invention is not limited to the exemplary embodiments elucidated here. It is, in particular, possible for the server system S and the client system C2 of the second user to be combined in one system unit, which would be the case if the operator of an internet marketplace for products and/or services were also a supplier of products and/or services.

1. Method for processing information on product request processes, wherein
product information with at least one product identifier (PID) is visualized on a user interface device (MMI) and a function for producing a product availability request is made available to at least a first user for activation,
on activation of said function a user (CID) and product identifier (PID) are polled, a request process file (ODF1-ODFn) for product request process information, which may be addressed by means of a request process identifier (OID), is generated,
the user identifier and the product identifier are entered in the request process file and a message (PRQ) containing the request process identifier is sent to at least one second user,
after generation of the request process file (ODFl-ODFn) the above is made available to the second user for editing and after the entries stored in the request process file (ODFL- ODFn) have been confirmed by the second user, a function for generating a product order is made available to the first user for activation.

2. Method according to claim 1, characterized in that
when the function for producing a product availability request for the request process file (ODF1-ODFn) is activated, a file status memory (STA) assigned to the latter is initialized,
entries stored in the request process file are made available for editing to at least the first and/or second user depending on a value stored in the file status memory and
the value stored in the file status memory is changed after the confirmation.

3. Method according to claim 2, characterized in that
a reserved area in the request process file (ODF1-ODFn) is made available for the file status memory (STA).

4. Method according to one of claims 1 to 3, characterized in that
when the function for the product order is activated, a product order message (POR) is automatically sent to the second user and a function for confirming a product order is made available to the second user for activation and
when the function for confirming the product order is activated, a product order confirmation message (COR) is automatically sent to the first user.

5. Method according to one of claims 1 to 4, characterized in that
only one request process file (ODF1-ODFn) is made available in each case for each product availability request process.

6. Method according to one of claims 1 to 4, characterized in that
only one request process file (ODF1-ODFn) is made available in each case for each product availability request process involving a subsequent order process.

7. Method according to one of claims 1 to 6, characterized in that
the user interface device (MMI) for user access is set up on an internet portal.

8. Computer program for processing information on product request processes that can be loaded into a working memory of a computer and has code sections on the execution of which product information with at least one product identifier (PID) is visualized on a user interface device (MMI) and a function for producing a product availability request is made available to at least a first user for activation,
on activation of said function a user (CID) and product identifier (PID) are polled, a request process file (ODF1-ODFn) for product request process information, which may be addressed by means of a request process identifier (OID), is generated,
the user identifier and the product identifier are entered in the request process file and a message (PRQ) containing the request process identifier is sent to at least one second user,
after generation of the request process file (ODF1-ODFn) the above is made available to the second user for editing and after the entries in the request process file (ODF1-ODFn) have been confirmed by the second user, a function for generating a product order is made available to the first user for activation,
when the computer program is running on the computer.
